(19) United States
(12) Patent Application Publication
(10) Pub. No.: US 2018/0155206 A1
(43) Pub. Date: Jun. 7, 2018

(54) METHOD OF PRODUCING HIGH-PURITY NANO ALUMINA

(71) Applicant: SAMHWA YANG HENG CO., LTD., Seoul (KR)

(72) Inventor: Sang Cheol BAE, Jeollanam-do (KR)

(21) Appl. No.: 15/814,546

(22) Filed: Nov. 16, 2017

(30) Foreign Application Priority Data
Dec. 6, 2016 (KR) 10-2016-0164888

(51) Int. Cl. C01F 7/30; C01F 7/34

(52) U.S. Cl. CPC C01F 7/30; C01P 2004/62; C01P 2006/80; C01F 7/34

(57) ABSTRACT

A method of producing a high-purity nano alumina powder, in which general aluminum hydroxide is dissolved in a sodium hydroxide solution to give a sodium aluminate solution, most insoluble impurities other than sodium are removed using a micro filter to give a pure sodium aluminate solution. A seed is added thereto so as to precipitate nano aluminum hydroxide as a nano slurry under optimal precipitation conditions. The nano aluminum hydroxide slurry is filtered, dried, disintegrated, and then calcined at a low temperature of 900° C. or less, thus achieving the mass production of high-purity nano alumina having a particle size of 200 nm or less, whereby high-purity alumina nanoparticles can be produced in an environmentally friendly manner at low cost.

### CROSS REFERENCE TO RELATED APPLICATION

The present application claims priority to Korean Patent Application No. 10-2016-0164888, filed Dec. 6, 2016, the entire contents of which are incorporated herein for all purposes by this reference.

### BACKGROUND

### 1. Technical Field

The present invention relates to a method of producing high-purity nano alumina.

### 2. Description of the Background Art

High-purity nano α-alumina (α-Al₂O₃) is superior in teams of insulating properties, heat resistance, wear resistance, and corrosion resistance, and moreover, a nanopowder thereof, having low calcination and sintering temperatures, is widely utilized for ceramic filters, high-purity crucibles, sintered high-purity alumina for sapphire ingots, abrasives, electronic parts, fillers, catalyst carriers, separator coating agents for secondary batteries, and the like. In particular, high-purity nano α-alumina is employed in fine ceramics or electronic parts.

High-purity α-alumina is conventionally obtained through a modified alum method in a manner in which general aluminum hydroxide is dissolved using a sodium hydroxide (NaOH) solution, the dissolved solution is treated to adsorb impurities therein using a pulp-type adsorbent and filtered and thus purified, and the purified solution is subjected to a Bayer Process to precipitate high-purity aluminum hydroxide, which is then dissolved again in sulfuric acid and neutralized with ammonia. Alternatively, an aluminum alkoxide hydrolysis method, a quaternary ammonium aluminate method, an alum pyrolysis method, an ammonium aluminum carbonate pyrolysis method, an aluminum chloride pyrolysis method, an underwater glow discharge method, or the like may be used.

However, the aforementioned methods are problematic because the production process is complicated, the raw materials that are used are expensive, and the price of the resulting α-alumina is very high owing to environmental and equipment costs.

### SUMMARY

Accordingly, the present invention has been made keeping in mind the problems encountered in the art, and an aspect of the present invention is to provide a method of producing high-purity nano alumina, which is performed through a simple process and enables the production of high-purity nano alumina having a purity of 99.998% or more and an average particle size of less than 300 nm.

The aspects of the present invention are not limited to the foregoing, and other aspects not mentioned herein will be able to be clearly understood by those skilled in the art from the following description.

Therefore, an embodiment of the present invention provides a method of producing high-purity nano alumina, including:

preparing a sodium aluminate mother solution by dissolving and aging aluminum hydroxide;

removing impurities from the mother solution by filtering the mother solution through a filter membrane;

precipitating a nano slurry by adding an aluminum hydroxide seed to the mother solution having no impurities;

performing classification by separating a grown particle slurry and a non-grown particle slurry, filtering the grown particle slurry to give a solid and a filtrate and using the non-grown particle slurry as the seed, and washing and drying the solid and using the filtrate as a solvent for dissolving the aluminum hydroxide;

preparing calcined alumina by calcining the washed and dried solid (ultrafine aluminum hydroxide); and

obtaining high-purity nano alumina by dispersing the calcined alumina in ultrapure water in order to remove a trace amount of impurities from the calcined alumina and to disperse the particles and then performing filtration and drying.

According to a preferred embodiment, preparing the mother solution includes: a dissolution process, including placing general aluminum hydroxide and sodium hydroxide (NaOH) in a dissolution bath and dissolving the general aluminum hydroxide to give a mother solution, and an aging process, including aging impurities in the mother solution while slowly decreasing the temperature of the mother solution for a predetermined aging time.

In addition, an embodiment of the present invention provides a method of producing high-purity nano alumina, including:

a dissolution step, including placing a sodium hydroxide (NaOH) solution and general aluminum hydroxide in a dissolution bath and dissolving the general aluminum hydroxide to give a mother solution;

a purification step, including slowly decreasing the temperature of the mother solution for a predetermined time to age impurities therein and filtering the aged mother solution through a filter membrane (fine hole size: 0.5 μm) made of Teflon material to remove impurities from the mother solution;

a precipitation step, including separating the filter membrane having impurities attached thereto, moving the purified mother solution to a precipitation bath, and feeding an aluminum hydroxide seed to the mother solution in the precipitation bath to precipitate aluminum hydroxide;

a classification step, including separating a precipitate having a large particle size and a precipitate having a small particle size from each other; and

a treatment step, including filtering the mother solution containing the precipitate having a large particle size to give a filtrate, recycling the filtrate to the sodium hydroxide solution, and washing and drying the filtered precipitate.

According to a preferred embodiment, the precipitate having a large particle size separated in the classification step is washed with warm water and then dried at 140° C. or less.

According to a preferred embodiment, the aluminum hydroxide dried in the classification step is calcined at 1000° C. or less for 1 hr or more to give α-alumina, which is then cooled to 300° C. or less, after which a rinsing bath is filled with deionized water in an amount five times the weight of the solid, and the calcined solid is placed therein and maintained for 1 hr or more with stirring at 100 rpm or more, filtered, dried at 100° C. or more using a cake dryer, and packaged.

According to a preferred embodiment, in the dissolution step, the aluminum oxide/sodium hydroxide weight ratio (Al₂O₃/Na₂CO₃) in the dissolved mother solution is 0.63˜069.

According to a preferred embodiment, in the dissolution step, the concentration of sodium hydroxide (NaOH) is 200 g/L to 250 g/L based on sodium carbonate (Na₂CO₃).

According to a preferred embodiment, the temperature of the mother solution before filtration to remove impurities after the dissolution step may be maintained at 130˜190° C. for a predetermined time or more.

According to a preferred embodiment, in the dissolution step, the aging maintenance time for aging impurities may be 1 hr or more.

According to a preferred embodiment, the precipitation step may be performed at an initial temperature of 80° C. or less.

According to a preferred embodiment, the precipitation step may be performed for 20 hr or more so as to precipitate aluminum hydroxide.

According to a preferred embodiment, in the precipitation step, the final aluminum oxide/sodium hydroxide weight ratio (Al₂O₃/Na₂CO₃) may be 0.42 or less.

According to a preferred embodiment, in the calcination step, the calcination temperature of 800° C. or more may be maintained for a predetermined time or more.

According to a preferred embodiment, the temperature of the calcined material added to the pure water is 300° C. or less, and may be maintained for a predetermined time with stirring after the addition thereof.

According to a preferred embodiment, the pure water may be used in an amount at least two times the weight of the calcined material.

One or more embodiments of the present invention can exhibit the following superior effects.

The method of producing high-purity nano alumina according to an embodiment of the present invention can completely solve problems regarding waste and yield owing to the use of a conventional adsorbent, thereby producing high-purity alumina at high productivity in an economical and environmentally friendly manner.

Also, in the method of producing high-purity nano alumina according to an embodiment of the present invention, general aluminum hydroxide is dissolved in sodium hydroxide and then filtered using a filter cloth, thereby simply removing impurities and enabling the mass production of high-quality products, unlike when using a conventional adsorbent. Furthermore, in order to minimize Na content, a chemical process is not performed but a rinsing process is performed after a calcination process, thereby realizing mass production of high-purity alumina at high quality and low cost compared to existing methods.

### BRIEF DESCRIPTION OF THE DRAWING

FIG. 1 is a block diagram showing a process of producing high-purity nano alumina according to an embodiment of the present invention.

### DETAILED DESCRIPTION

While the present invention has been described using terms relating to what is presently considered to be the most practical and preferred embodiment, in certain cases, there may be a term arbitrarily selected by the applicant, in which case the meaning thereof should be understood based not on the name of a simple term but on the meaning of the term described or used in the detailed description of the invention.

Hereinafter, the technical constitution of the present invention will be described in detail with reference to preferred embodiments shown in the accompanying drawings.

However, the present invention is not limited to the embodiments described herein, but may be embodied in other forms. Like reference numerals denote like elements throughout the specification.

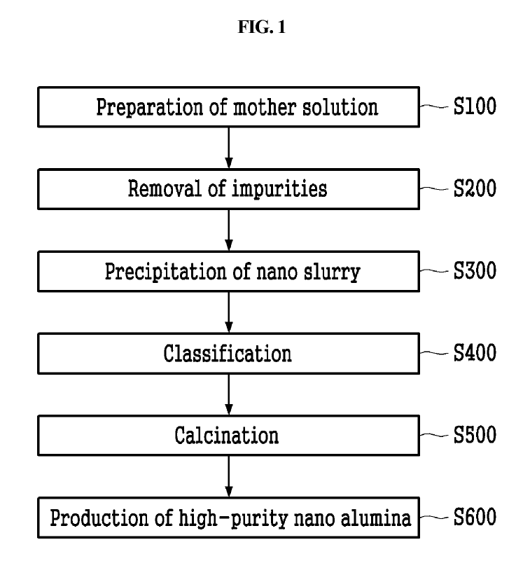

FIG. 1 is a block diagram showing the process of producing high-purity nano alumina according to an embodiment of the present invention.

With reference to FIG. 1, the method of producing high-purity nano alumina according to an embodiment of the present invention includes preparing a mother solution by dissolving and aging aluminum hydroxide (S100), removing impurities from the mother solution using a filter membrane (S200), precipitating a nano slurry by adding a seed to the mother solution having no impurities (S300), performing classification by separating a grown particle slurry and a non-grown particle slurry, filtering the grown particle slurry to give a solid and a filtrate and using the non-grown particle slurry as the seed, and washing and drying the solid and using the filtrate as a solvent for dissolving the aluminum hydroxide (S400), preparing calcined alumina by calcining the dried ultrafine aluminum hydroxide (S500), and obtaining high-purity nano alumina by dispersing the above solid in ultrapure water in order to remove a trace amount of impurities from the calcined alumina and to disperse the particles and then performing filtration and drying (S600).

In the method of producing high-purity nano alumina according to an embodiment of the present invention, aluminum hydroxide having high purity may be prepared by dissolving general aluminum hydroxide in a sodium hydroxide (NaOH) solution and aging the dissolved solution to give a mother solution, which is then passed through a micro filter (made of Teflon), thus selectively removing only impurities from the aged solution, before a Bayer process.

The impurities present in the mother solution in which aluminum hydroxide is dissolved are aged, whereby coagulated impurities therein are removed via a filter membrane having fine holes. After removal of impurities such as Fe, Si, Ti, and Ca, except for Na, the seed is fed to precipitate nano-sized aluminum hydroxide, after which high-purity aluminum hydroxide containing a minimum of Na is calcined at a low temperature and then rinsed, thereby yielding high-purity nano alumina containing 5 ppm or less of Na.

In order to produce high-purity alumina according to an embodiment of the present invention, as a starting material, a supersaturated sodium aluminate (NaAl(OH)₄) solution is used. The supersaturated sodium aluminate solution is obtained by dissolving aluminum hydroxide (Al(OH)₃) in a high-concentration sodium hydroxide (NaOH) solution through heating and pressing.

In the method of producing high-purity nano alumina according to an embodiment of the present invention, the supersaturated sodium aluminate solution thus obtained is aged and then passed through a micro filter, whereby impurities are removed from the sodium aluminate solution, thus purifying the sodium aluminate solution.

Thereafter, the purified sodium aluminate solution is fed with the seed so as to initiate precipitation at a high temperature. As such, the processing temperature is slowly decreased for a long time, whereby the precipitate is formed at a low temperature, thus preparing a nano slurry.

Thereafter, the precipitated solid is filtered, washed, dried, and then transformed into an α-phase at 900° C. or more to form α-alumina, which is then slowly cooled to 300° C. or less, after which the resulting solid is fed into ultrapure cooling water, stirred for a predetermined time, filtered and dried, thus yielding high-purity nano alumina.

The method of producing high-purity nano alumina according to an embodiment of the present invention provides, as shown in FIG. 1, various and experimental processes in order to increase the purity of the finally obtained alumina.

The method of producing high-purity nano alumina according to an embodiment of the present invention is specified below.

Specifically, in order to prepare a sodium aluminate mother solution, 200˜250 g/L of a sodium hydroxide (NaOH) solution based on sodium carbonate (Na₂CO₃) is placed in a dissolution bath made of stainless steel (SUS 316L) capable of increasing the temperature and pressure therein, and water-containing general aluminum hydroxide is added so as to realize an Al₂O₃/Na₂CO₃ weight ratio (A/C:weight ratio) ranging from 0.63 to 0.67, after which the temperature is elevated to 130˜140° C. with stirring at a rate of 30 rpm to disperse aluminum hydroxide, maintained at that temperature for about 10 min, cooled to 80˜100° C. and then maintained at that temperature for 1 hr or more.

As is apparent from Tables 1 and 2 below, in order to prepare the mother solution in which aluminum hydroxide is completely dissolved at a 0.65 weight ratio (A/C) of the mother solution, the sodium hydroxide concentration is set to 230 g/L, placed in the dissolution bath, heated to 140° C. and then maintained for 10 min.

In this way, when the aluminum hydroxide is completely dissolved so that the A/C of the mother solution is 0.65, the mother solution is gently stirred using a stirrer to coagulate impurities therein, after which the temperature of the mother solution is slowly decreased to 80° C. over 1 hr or more and maintained for 3 hr, thus aging the mother solution. Here, the reason why the mother solution is aged is to increase the particle size of impurities contained in the mother solution so as to facilitate the removal of the impurities, as described above.

TABLE 1
Product effects depending on Al₂O₃/Na₂CO₃ weight
ratio of (230 g/L, Na₂CO₃) purified mother solution

| A/C | 0.59 | 0.61 | 0.63 | 0.65 | 0.67 | 0.69 | 0.71 |
|---|---|---|---|---|---|---|---|
| Fe (ppm) | 5 | 3 | 2 | 1 | 1 | 1 | 1 |
| Ca (ppm) | 4 | 2 | 1 or | 1 or | 1 or | 1 | 1.2 |
| | | | less | less | less | | |

TABLE 2
Product effects depending on sodium hydroxide (NaOH) concentration
of (A/C, 0.65) mother solution (mother solution: 0.65)

| Na₂CO₃ g/L | 200 | 210 | 220 | 230 | 240 | 250 | 260 |
|---|---|---|---|---|---|---|---|
| Fe (ppm) | 1 | 1 | 1 | 1 | 2 | 2 | 4 |
| Ca (ppm) | 1 or | 1 or | 1 or | 1 or | 1 or | 2 | 13 |
| | less | less | less | less | less | | |

Next, with regard to the mother solution, which has been aged well in order to remove impurities therefrom, the hole diameter of the filter cloth made of polyethylene used for the filter membrane having the highest removal efficiency is 0.5 μm.

TABLE 3
Hole size of filter cloth (made of polyethylene) attached to
filter press

| | Hole size of filter cloth | | | | |
|---|---|---|---|---|---|
| | 0.3 μm | 0.5 μm | 1 μm | 10 μm | 100 μm |
| Fe (ppm) | 1 | 1 | 2 | 9 | 20 |
| Ca (ppm) | 1 or less | 1 or less | 3 | 10 | 14 |

In order to remove impurities from the mother solution, filtration is performed at 2 atm using a filter press having a filter cloth having a hole size of 0.5 μm attached thereto and made of polyethylene with a filtration area of 25 cm (width)×25 cm (length) for 1 m³ of the mother solution to give a clean mother solution having no impurities, which is subsequently moved to the precipitation bath, and the filter cloth having impurities adsorbed thereto is washed.

The purified mother solution having no impurities is then subjected to a nano slurry precipitation process. Here, the Al₂O₃/Na₂CO₃ weight ratio of the mother solution is 0.65 and the temperature thereof is maintained at 80° C. The precipitation process is performed under the condition that the stirrer rate is increased so that the precipitate and the seed float. 200 g of the aluminum hydroxide seed (having an average particle size of 0.5 μm) for 1 L of the mother solution is added to facilitate precipitation, and precipitation is initiated at 80° C. as shown in Table 4 below and is performed for 20 hr more as shown in Table 5 below.

TABLE 4
Particle size of precipitate depending on initial precipitation
temperature (20 wt % of seed precipitate, precipitation
time of 72 hr)

| | Precipitation temperature | | | | |
|---|---|---|---|---|---|
| | ° C. (Initial-Final) | | | | |
| | 100-50 | 90-50 | 80-50 | 70-50 | 60-50 |
| Average size μm | 2.0 | 1.8 | 1.0 | 1.0 | 2.2 |
| Primary particle | 1.5-1 | 0.3-0.8 | 0.1-0.4 | 0.1-0.4 | 0.1-0.4 |
| size μm | | | | | |

TABLE 5
Final Al₂O₃/Na₂CO₃ weight ratio of processing solution after
precipitation for different precipitation times (final
precipitation temperature of 50° C., initial precipitation
temperature of 80° C., 200 g/L of seed, average seed particle
size of 0.5 μm)

| Precipitation time A/C | 10 hr | 20 hr | 30 hr | 40 hr | 50 hr |
|---|---|---|---|---|---|
| Final weight ratio (A/C) | 0.38 | 0.34 | 0.34 | 0.34 | 0.34 |

TABLE 6
Final Al₂O₃/Na₂CO₃ weight ratio of processing solution after
precipitation using the seed in different amounts (wt % relative
to the processing solution) (final precipitation temperature of
50° C., initial precipitation temperature of 80° C., average
seed particle size of 0.5 μm)

| | Amount of seed used relative to | | | | |
|---|---|---|---|---|---|
| | processing solution | | | | |
| | 5% | 10% | 15% | 20% | 25% |
| Final weight ratio (A/C) | 0.40 | 0.38 | 0.37 | 0.34 | 0.34 |

The precipitate obtained by the above precipitation process is alumina, the amount of impurities increasing with a decrease in the amount of sodium hydroxide (NaOH). Hence, the precipitation conditions able to maximize the amount of sodium hydroxide are as follows: an initial precipitation temperature of 80° C., a final precipitation temperature of 50° C., and a minimum precipitation time of 20 hr or more, whereby the weight ratio (A/C) of the final precipitate is 0.34 or less. In this way, when the weight ratio (A/C) of the final precipitate is 0.34 or less, desired quality and competitiveness may be ensured.

Next, a classification process is performed.

In the classification process, the non-grown precipitate having an average particle size of 0.5 μm or less is separated using a Cyclone classifier, and is thus used as the aluminum hydroxide seed that is added during the precipitation process.

The well-grown precipitate (having an average particle size of 1 μm) is filtered and separated, and the filtrate is recycled to the sodium hydroxide solution necessary for the dissolution process and the filtered cake is washed and dried.

After the classification process, a calcination process is performed in a manner in which the well-dried aluminum hydroxide solid having an average particle size of 1 μm is calcined at 900° C. for 1 hr or more so as to be transformed into α-alumina.

Thereafter, in order to remove a trace amount of Na from the α-alumina and to disperse particles, as shown in Table 7 below, the calcined α-alumina is cooled to 300° C. or less, and ultrapure water is placed in an amount at least five times the weight of calcined alumina in a tank equipped with a stirrer, after which the calcined alumina is added thereto, rinsed, dispersed with stirring, and then filtered using a filter press.

Thereafter, a rinsing process for drying the filtered cake using a cake dryer to obtain high-purity nano alumina, a drying process for drying the solid, separated from the filtrate through filtration, at 120° C. or more, and a packaging process using a moisture-proof paper in order to prevent contamination with foreign matter are sequentially performed, thereby yielding a high-purity nano alumina powder containing 50 ppm or less of impurities and having an average particle size of 300 nm or less, which enables economical and environmentally friendly mass production.

TABLE 7
Na content of product depending on amount of rinsing solution
(Na content before rinsing: 60 ppm)

| | Amount of ultrapure water used | | | | |
|---|---|---|---|---|---|
| | relative to calcined material | | | | |
| | 200% | 300% | 400% | 500% | 600% |
| Na content in final | 10 | 6 | 3 | 2 | 1.9 |
| product (ppm) | | | | | |
| Average particle size | 1.2 | 1.0 | 0.5 | 0.3 | 0.3 |
| of final product (μm) | | | | | |

TABLE 8
Comparison of high-purity alumina obtained by the method of
an embodiment of the present invention and conventional high-
purity alumina

| | High-purity nano alumina | |
|---|---|---|
| | obtained by an embodiment | Conventional high- |
| | of the present invention | purity alumina |
| Al₂O₃ % | 99.998 | 99.995 |
| Na ppm | <3 | <3 |
| Fe ppm | <1 | <3 |
| Si ppm | <2 | <3 |
| Ti ppm | <1 | <3 |
| Mg ppm | <1 | <3 |
| Ca ppm | <1 | <3 |
| Cr ppm | <1 | <3 |
| Average | <0.3 | <0.5 |
| particle size | | |
| (d50, μm) | | |

As described hereinbefore, the method of producing the high-purity nano alumina according to an embodiment of the present invention enables the mass production of high-purity nano alumina in a manner in which general aluminum hydroxide is dissolved using a sodium hydroxide (NaOH) solution, and the resulting solution is aged (the term “aging” means that the particles are grown in a dissolved state) to thus activate impurities and filtered through a filter membrane made of Teflon material to effectively purify the dissolved solution, after which the purified solution is subjected to a Bayer Process to precipitate high-purity nano aluminum hydroxide containing a minimum of Na, which is then dried and calcined at 1000° C. or less, thus affording α-alumina, which is then rinsed with ultrapure water and then dried at 140° C. or less.

Also, optimal conditions for the weight ratio of the mother solution, aging time, filtration temperature, precipitation temperature and time, etc. required to prepare the high-purity aluminum hydroxide are developed, whereby a high-purity nano alumina powder having a purity of 99.998% or more and an average particle size of 300 nm or less can be provided.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of producing high-purity nano alumina, comprising:
preparing a sodium aluminate mother solution by dissolving and aging aluminum hydroxide;
removing impurities from the mother solution by filtering the mother solution through a filter membrane;
precipitating a nano slurry by adding an aluminum hydroxide seed to the mother solution having no impurities;
performing classification by separating a grown particle slurry and a non-grown particle slurry, filtering the grown particle slurry to give a solid and a filtrate and using the non-grown particle slurry as the seed, and washing and drying the solid and using the filtrate as a solvent for dissolving the aluminum hydroxide;
preparing calcined alumina by calcining the washed and dried solid; and
obtaining high-purity nano alumina by dispersing the calcined alumina in ultrapure water in order to remove a trace amount of impurities from the calcined alumina and to disperse particles and then performing filtration and drying.

2. The method of claim 1, wherein the preparing the mother solution comprises:
dissolving aluminum hydroxide in a sodium hydroxide (NaOH) solution to give a sodium aluminate mother solution, and
aging the sodium aluminate mother solution so as to age impurities therein.

3. The method of claim 2, wherein the mother solution is configured such that an aluminum oxide/sodium carbonate (Al₂O₃/Na₂CO₃) weight ratio is 0.65 to 0.69.

4. The method of claim 2, wherein a concentration of the sodium hydroxide is 200 g/L to 230 g/L based on sodium carbonate (Na₂CO₃).

5. The method of claim 1, wherein the precipitating the nano slurry is performed at an initial temperature of 60° C. or more.

6. The method of claim 3, wherein the performing the classification is carried out using a filter cloth having a hole diameter of 10 μm or less to purify the mother solution.

7. The method of claim 3, wherein the precipitating the nano slurry is performed for 20 hr or more so as to precipitate aluminum hydroxide.

8. The method of claim 1, wherein the ultrapure water is used in an amount at least two times a weight of the calcined alumina.
